(19) United States
(12) Patent Application Publication
(10) Pub. No.: US 2007/0003088 A1
(43) Pub. Date: Jan. 4, 2007

(54) Hearing aid compatible mobile phone and method

(75) Inventor: Esa Antero Lehtola, Turku (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/168,663

(22) Filed: Jun. 27, 2005

(51) Int. Cl. H04R 25/00

(52) U.S. Cl. 381/330

(57) ABSTRACT

An electronic device includes a ground plane with two opposed edges, and an electrical component such as a second ground plane, a speaker, or a telecoil. The electrical component is spaced from the ground plane. An electrical conductor couples the electrical component to a point on the ground plane that is substantially spaced from each of the opposed edges, preferably where an electric field measures no greater than about one third of a ground plane maximum electric field when the mobile station operates in a receiving mode. Further, the electrical component is disposed so as to not overlie the point with respect to a major surface of the ground plane. An antenna is resonantly coupled to the ground plane, but not resonant with the second ground plane if present. Preferably, the conductor is RF shielded. Embodiments for monoblock and extendable device designs are disclosed. Also, a method for providing a hearing aid compatible wireless electronic device is detailed.

### TECHNICAL FIELD

The present invention relates to an electronic device, especially a mobile phone, that exhibits reduced interference with a user's hearing aid particularly by wiring modifications. It is also directed to a method for modifying a mobile phone to be hearing aid compatible.

### BACKGROUND

Despite broad advances in communications technology over the past decades, audible-based telecommunications have generally not fully addressed the needs of persons with hearing impairments. While TDD/TTY devices satisfy basic telephonic needs for this population, they are increasingly of marginal use given trends in the broader population. For example, between thirty and fifty percent of emergency calls are now made from mobile phones. The Hearing Aid Compatibility Act of 1988 (HAC Act) mandated that all telephones made or imported into the United States be compatible with hearing aids, but specifically exempted mobile telephones. In July 2003, the Federal Communications Commission FCC modified the HAC Act's exemption for mobile phones, mandating that manufacturers provide certain numbers of models or percentages of mobile phones that are hearing aid compatible HAC by 2005 and 2008.

There are generally two principal conditions of exposure that subject users to undesirable RF emissions from wireless electronic devices that interfere with their hearing aids. A far-field condition reflects the type of field a hearing aid would experience if its wearer were standing next to someone using a wireless device. A near-field condition corresponds to the more intense fields that a hearing-aid user is susceptible to when using a cellular phone or other wireless device. The following description and the present invention are directed toward mitigating the near-field condition, to which the FCC's July. 2003 ruling applies.

Hearing aid users often experience a buzzing sound that makes it difficult or impossible for them to hear conversations over standard digital wireless handsets. Digital wireless telephones emit electromagnetic energy from the antennas and backlights or other components of digital mobile telephones that often interferes in the audio band with hearing aids or cochlear implants. This interference is generally not a concern with analog equipment, but analog wireless phone service is scheduled to be phased out in the U.S. by 2008. The FCC defines hearing-aid compatible as a) producing a magnetic field of sufficient strength and quality to permit coupling with hearing aids that contain telecoils, and b) provide an adequate range of volume. A telecoil or T-coil is a small, tightly wrapped piece of wire that, when activated, picks up a voice signal from the electro-magnetic field that leaks from compatible phones. Efforts to comply with the HAC Act for traditional (non-mobile) phones included equipping traditional phones with a telecoil, which coupled with a compatible telecoil in the user's hearing aid. This enabled effective communications for the user without feedback and amplification of background noise. A telecoil is an electromagnetic conductor that is tightly wrapped around a core that induces an electric field in the coil in the presence of a magnetic field. The telecoil or T-coil originally converted the magnetic field emanating from a non-HAC phone speaker (which were once driven by large magnets) into sound that is decipherable by the hearing aid user. Some HAC phones now also have a telecoil that allows it to direct “couple” to a compatible telecoil in the hearing aid, eliminating feedback and background noise, and creating an overall clearer sound for the hearing-aid equipped user. The user merely switches his/her hearing aid to a telecoil mode, activating the telecoil as the input source for the hearing aid. However, merely adding a telecoil to a mobile telephony handset is less effective than adding it to a traditional (non-mobile) phone, because mobile phones necessarily exhibit a much stronger magnetic field around the phone due to their wireless nature. This magnetic field may cause interference at the hearing aid telecoil.

There are two broad styles for mobile telephony handsets: monoblock, in which the size of the handset body is fixed, and extendable, in which one portion of the handset body is movably connected to another portion. Within the extendable category are flip phones (hinged connection, such as the Nokia model 6255i) and slide phones (slide connection, such as the Nokia model 7280), and generally are operational for two way communications only when the handset body portions are extended with respect to one another. Monoblock handsets are generally crowded internally to achieve a smaller overall size, and metallic components are located near the speaker, thus generating greater interference in hearing aids. Traditional extendable handsets offer more varied design choices for relative placement of internal components, but have historically not addressed the hearing aid interference problem.

Various solutions to better enable mobile telephony for the hearing impaired have generally been accessories for existing (non HAC) handsets, rather than a handset designed specifically for HAC. For example, the Nokia Corp. has won awards for its Loopset, an accessory that plugs into an existing (e.g., non HAC compatible) mobile phone and operates as a remote microphone and hearing aid compatible “speaker”. When the mobile phone is in use, a microphone built into the Loopset picks up the user's voice. The Loopset converts sound from the handset into a low-power magnetic field, which is picked up by the T-coil in the hearing aid (which must be switched to T-mode) and coverted back into sound. By using inductive technology, the sound from the handset is amplified more efficiently and background noise is eliminated more effectively. Proper operation requires that the Loopset is kept a distance away from the user's hearing aid, such as operating the handset while it is clipped to a user's belt. This is an adaptation to the telecoil coupling described above that avoids the increased magnetic field from the handset.

While the Loopset may be effective for its intended purpose, there is a need for mobile handsets that are hearing-aid compatible in and of themselves, rather than adapted by accessory. This is true both for the FCC requirements, and to enable those with hearing impairments to access more of the increasingly diverse features of mobile telephony, such as video mail or streaming video with matching audio, voice tags, ring tones, and the like. The present invention is directed to overcoming the above-mentioned interference problems in a mobile handset, without the need for accessories such as a Loopset.

### SUMMARY

The foregoing and other problems are overcome, and other advantages are realized, in accordance with the presently disclosed embodiments of these teachings.

In one aspect, the present invention is an electronic device that includes a ground plane defining two opposed edges, a separate electrical component, and an electrical conductor that couples the electrical component to a point on the ground plane that is substantially spaced from each of the two opposed edges. The electrical component is spaced from the ground plane, and does not overlie the point with respect to the ground plane. Overlying refers to a major surface of the ground plane, bounded by the edges. As an example, the electrical component would overlie the ground plane if it were mounted directly to a major surface thereof. Embodiments of the invention exclude such an arrangement.

In another aspect, the present invention is a mobile station that includes an antenna and a ground plane that is resonant with the antenna when the mobile station is in operation. A separate electrical component, such as a second ground plane, a speaker, or a telecoil, is coupled to the ground plane by a conductor that electrically couples the electrical component to a point on the ground plane that exhibits an electric field that is no greater than about one third of the ground plane's maximum electric field, as determined when the mobile station operates in a receiving mode. The electrical component is spaced from an edge of the ground plane and does not overlie the point.

In yet another aspect of the invention is a method for providing a hearing aid compatible wireless electronic device. In the method a housing is provided, in which is disposed an antenna and a ground plane coupled to and resonant with that antenna. An electrical component is also disposed in the housing, spaced from the ground plane. In the method, the electrical component is coupled by a conductor to a point of the ground plane that is substantially spaced from each of the two opposed edges of the ground plane. The electrical component is disposed so as not to overlie the point with respect to the ground plane.

In another aspect, the present invention is a wireless electronic device that has an antenna, a grounding means, an electrical component spaced from an edge of the grounding means at least when the antenna is active in a transmitting mode, and coupling means. The grounding means is coupled to the antenna and is resonant with it when the antenna is active. The grounding means further defines opposed edges. The coupling means is for electrically coupling the electrical component to a point of the grounding means that is substantially spaced from each of the opposed edges of the grounding means. The electrical component is positioned so as not to overlie the point with respect to the ground plane. Preferably, the grounding means is a first ground plane, and the electrical component is a second ground plane that is not resonant with the antenna when the antenna is active in the device.

Further details and embodiments are described below.

### BRIEF DESCRIPTION OF THE DRAWINGS

The foregoing and other aspects of these teachings are made more evident in the following Detailed Description of the Exemplary Embodiments, when read in conjunction with the attached Drawing Figures, wherein:

FIG. 1A is a perspective view of a traditional flip-type mobile station that incorporates features of the present invention.

Fig. 1B is a block diagram showing relevant internal components of the mobile station of FIG. 1A.

FIG. 2A is a perspective view of one embodiment of the present invention, with an upper housing section shown in cutaway.

FIG. 2B is a block diagram showing relevant internal components of the mobile station of FIG. 2A.

FIGS. 2C is a perspective view of the upper housing portion of FIG. 2A without the cutaway.

FIG. 3A is a plan view of a slide-type mobile phone.

FIG. 3B is an exploded block diagram of the slide-type phone of FIG. 3A, showing relevant internal components and embodying the present invention.

FIG. 4A is similar to FIG. 3A, but for a different embodiment of a slide-type phone.

FIG. 4B is similar to FIG. 3B, but for the embodiment of FIG. 4A.

FIG. 5 is a micrograph of a prior art speaker with unshielded lead wires.

FIG. 6 illustrates in perspective view the relevant components of the embodiment of FIG. 2B, but with proper relative sizes and physical disposition of the various components relative to one another.

FIG. 7A illustrates a two-dimensional plot of electric field strength superimposed over the various components as laid out in FIG. 5, but without aspects of the present invention incorporated in the measured mobile station.

FIG. 7B is similar to FIG. 7A, but with aspects of the present invention incorporated in the measured mobile station.

### DETAILED DESCRIPTION OF THE EXEMPLARY EMBODIMENTS

The term “hearing aid” in the following description includes any electronic aid to hearing that has an acoustic output, including behind-the-ear, in-the-ear, in-the- canal, and completely-in-the-canal types. Certain of these teachings may also be used to mitigate electrical interference with cochlear implants or similar aids to hearing that generate an electrical output to the user from an acoustic input.

Interference in hearing aids from mobile telephones is increased by having metallic material close to the speaker of the mobile telephone. This is true with traditional mobile phone handsets where the handset speaker is placed close to the user's ear and hearing aid, and is generally not a factor when the user utilizes a speakerphone function due to the distance between the handset and the hearing aid.

The present invention addresses the problem of hearing aid interference in two aspects, though not every aspect is necessary to gain the advantages of these teachings. First, the handset is designed so that the volume of metallic material near the speaker(s) is minimized, and the influence of remaining metallic material is minimized. In a clamshell or flip-type handset, few metallic components are disposed in the housing section in which the speaker and/or telecoil (whichever is adjacent to the user's hearing aid when in use) is disposed, or at least metallic components are generally not located immediately adjacent to the speaker. The same is true in slide-type handsets, where in an operational mode the section of the handset housing that bears the speaker/telecoil is slideably extended from a remaining housing section that bears the microphone. Also, electrically conductive wires in the vicinity of the speaker/telecoil are preferably RF-shielded, such as by a ferrite material. This is especially true for the wires that couple the speaker/telecoil to other handset components.

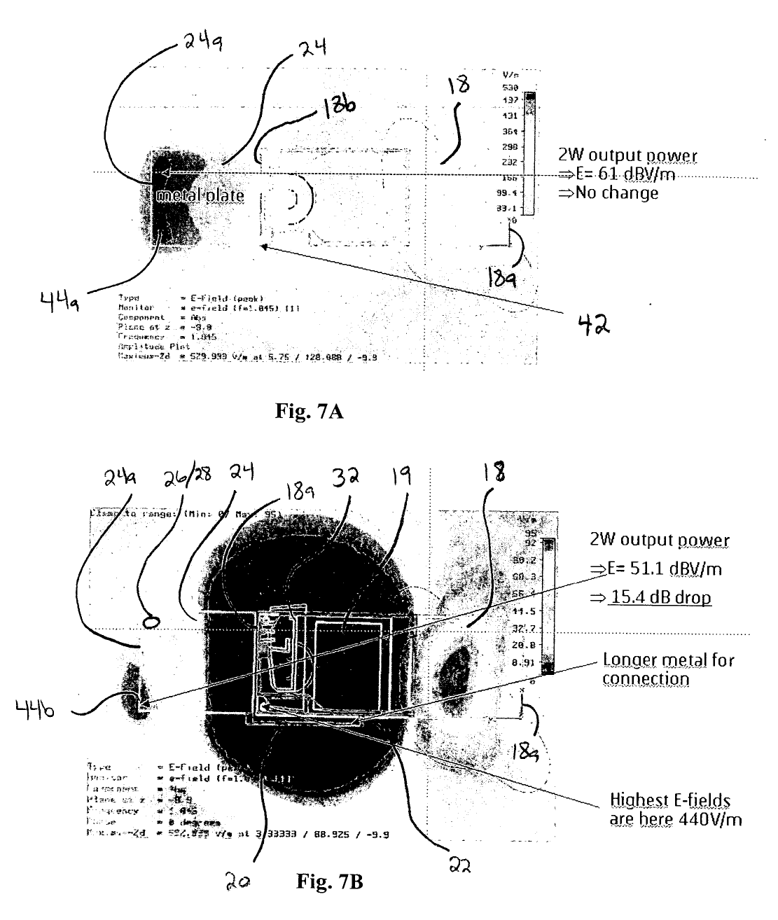

Second, the present invention addresses coupling of ground between components in one housing section of an extendable handset to a ground plane in the other housing section 14. That coupling, described below, minimizes the electric field at the location of the speaker or telecoil. Considering the housing section that carries the circuit board as the first section, the components in the opposed second housing section may be the speaker, a telecoil, or a ground plane of another circuit board. This second aspect may be implemented to advantage even in monoblock-style wireless devices, to which the quantitative advantage shown in FIGS. 7A and 7B is readily adaptable. Further details and examples of different embodiments are presented below.

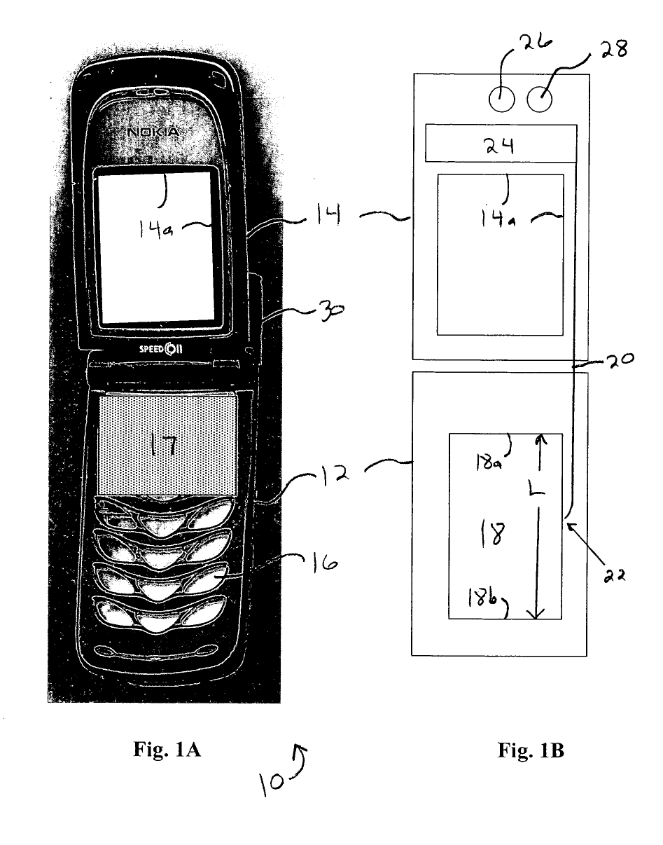

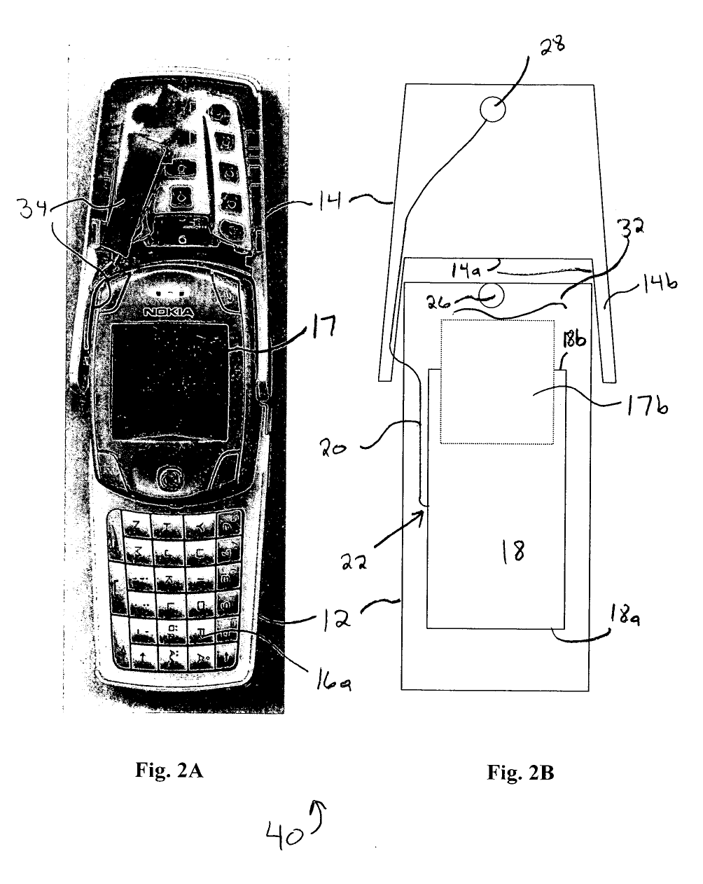

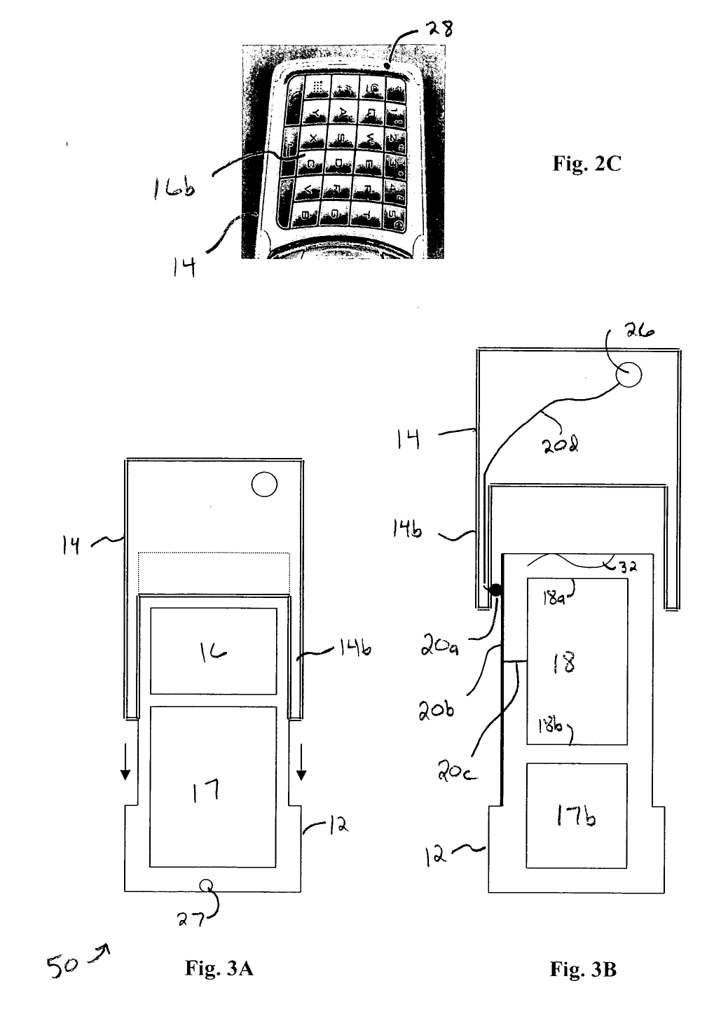

FIG. 1A is a perspective view of the present invention embodied as a flip-type mobile station 10, wherein a first housing section 12 is hingedly coupled to a second housing section, and two-way communications typically are only enabled when the two housing sections are open/extended relative to one another. FIG. 1B is a block diagram showing relevant internal components of the same mobile station of FIG. 1A. A keypad 16 and a display 17 are disposed within the first housing section 12. A whip antenna 30 is also shown with a stub extending from the first housing section 12, but an antenna that is internal to the first housing section 12 may also be used in place of or in addition to a whip antenna. Within the first housing 12 is a main circuit board, also termed the engine PWB (printed wiring board) that directs inputs from the keypad/buttons to a digital signal processor, and outputs from the signal processor to the display 17. The main circuit board may be considered to occupy the area 18 of FIG. 1B, as will be described. Also disposed on the main circuit board are a transceiver, a modulator, an encoder/decoder, various memories for computer programs and codebooks, and other hardware and software that enables mobile telephony. Some of these components may be located elsewhere, but the main digital signal processor is disposed on the main circuit board. Components on the main circuit board operate with reference to a common potential or ground, physically embodied as a ground plane 18 which may be a substantially planar mass of metal affixed to the main circuit board, or a discrete layer spanning the entire main circuit board, or most commonly an internal layer of metal within the main circuit board. As such, the main circuit board of FIG. 2B may extend beyond the indicated area 18. The ground plane is generally rectangular, and defines two sets of opposed edges. One set of opposed edges 18a, 18b defines a longer distance or length between them than the other set of opposed edges.

The second housing section 14 defines an electrical component that is coupled via an electrical conductor 20 to a point 22 on the ground plane that is substantially spaced from each of two opposed ground plane edges 18a, 18b. The electrical component is spaced from all lateral edges of the ground plane 18, and does not overlie the point 22 with respect to the ground plane 18 (e.g., it is not mounted directly over the connection point 22). Preferably, where the distance between ground plane edges is L, the point 22 is located at least L/3 from each edge 18a, 18b, and most preferably is located approximately midway along the length L. It is convenient but not necessary that the point 22 lie along an edge of the ground plane 18. The electrical component within the second housing section 14 that couples to the point may be a secondary ground plane 24 associated with another circuit board within the second housing section 14, or it may be a speaker 26 or telecoil 28 within that second housing section 14. Most preferably, a second ground plane 24 is coupled to the first ground plane 18 as described, and other components within the second housing section 14 are grounded to the second ground plane directly 24. The conductor 20 is preferably shielded along substantially its entire length by RF shielding such as a strip of ferrite material, also known as a ferrite carpet.

In order to reduce the volume of metallic material in the second housing section 14, in some embodiments it may define a plurality of interior edges 14a that bound an aperture or window that may or may not be occupied by a transparent plate. In FIG. 1B, when the handset 10 is folded and the first and second housing sections lie adjacent to one another, the display 17 is viewable by a user through the window and the interior edges 14a frame the display entirely. This avoids the need to dispose components necessary for the display 17 in the second housing portion 14, where they are traditionally disposed in flip-type phones. The mobile station may employ a whip antenna 30 as in FIG. 1A, and/or an internal antenna, either or both of which is coupled to the ground plane 18 such that together, the antenna/ground plane pair form a resonant pattern when the antenna actively radiates. The antenna may be of any type, including monopole, branched, dipole, PIFA, and the like. Where the antenna 30 is resonantly coupled to the first ground plane 18, it is important that the second ground plane 24 is not in resonance with the antenna 30 at the transmission/reception frequencies. If it were, currents in the region of the second housing section 14 would be increased, increasing electric and magnetic fields that adversely interfere in the audio band with the user's hearing aid. Preferably, the separation distance between the ground planes 18, 24 should be as large as possible given the mathematical constraints of the housings 12, 14 so as to minimize the coupling between the two closest adjacent edges of the ground planes 18, 24.

The point 22 at which the component(s) in the second housing section 14 connects to the ground plane is an important aspect of the present invention. In the prior art, the connection between ground planes of the different housing sections 12, 14 generally followed a shortest-distance criterion such as illustrated at reference number 42 of FIG. 7A, because internal spaces of mobile telephones are crowded. The center of the ground plane (either geometric center or center along an edge) corresponds to an area of minimal voltage and low electric field strength, and of maximum current. When the electrical conductor 20 is coupled near that center and shielded, surface currents along the conductor 20 are suppressed. Electric fields in the vicinity of the speaker 26 or telecoil 28 are minimized when the second ground plane 24, to which the speaker 26 or telecoil 28 is coupled (or alternatively the speaker 26 or telecoil 28 itself) is connected to that portion of the main ground plane 18 that exhibits lower voltage than the edge 18a, 18b, where the prior art coupled them. The midpoint along the length of the ground plane represents minimal voltage and field strength in the ground plane, so coupling there yields minimal electric fields near the speaker 26. Coupling near but not exactly at the midpoint yields a correspondingly lowered improvement as compared to the minimal electric field when coupled directly at the midpoint. The reduction of electric fields near the speaker 24 directly leads to reduced near-field interference with a hearing aid.

The advantages of the present invention may also be realized in a flip-phone in which the display 17 is disposed in the second housing section 14. This may be a practical implementation, as providing an aperture or window as described with FIGS. 1A-1B represents a significant loss of volume within which to locate components. Important aspects, such as RF shielding and coupling the conductor 20 at a point 22 that is near midway along the ground plane length L still provide a significant advantage to make a mobile station hearing aid compatible. Additional interference suppression may be obtained by disposing the battery (or other galvanic power source) and the power amplifiers between the antenna 30 and the transmitter/receiver blocks within the first housing section 12. This allows short power supply leads from the battery to the main circuit board and power amplifiers. Power leads add to the electric fields around nearby components, so disposing the battery and power amplifiers in the first housing section 12 enables shorter power leads and avoids interference at the distant speaker 26.

Another embodiment is shown in FIG. 2A-2B, where FIG. 2A is a perspective view of an embodiment of the present invention with the second housing section 14 shown in cutaway and FIG. 2B is a corresponding block diagram of relevant components. Only those aspects that differ from FIGS. 1A-1B are particularly described, and like reference numbers indicate like components. In this embodiment of a mobile station 40, the interior edges 14a of the second housing section 14 only partially envelope the display 17 when the first and second housing sections 12, 14 are closed relative to one another, rather than fully as with FIG. 1A-1B. This is because the housing sections 12, 14 are not hinged at edge portions, but near terminal ends of arms 14b of the second housing section 14 that extend alongside the first housing portion 12. The conductor 20 passes through these arms 14b and couples to components (e.g., the first ground plane 18) in the first housing portion 12 by any of several means known in the art, including a wire, a clock spring, and mating rotating bezels. In the embodiment of FIG. 2A-2B, there is illustrated a separate display circuit board 17b in dashed lines, disposed over the main circuit board. In such an arrangement, the portion of the conductor 20 that runs adjacent to the display circuit board 17b is also RF shielded by a ferrite blanket or the like. Such a ferrite blanket 34 is illustrated in FIGS. 2A, which illustrates a telecoil 28 (at FIG. 2B) in the second housing portion 14 but no second ground plane.

The ferrite blanket is but one embodiment for shielding the conductor 20 from the circuit board 17b and its associated ground plane(s). Alternatively or additionally, ferrite chips (known under various terms such as ferrite chips, multilayer ferrite chip beads and ferrite beads, commercially available from suppliers such as AEM, Inc.; SMEC, Inc.; and King Core Electronics, Inc.) may be placed along the main and display circuit boards, preferably along an edge adjacent to the conductor 20, and most preferably near the point 22 where the conductor 20 attaches. A ferrite toroid is also effective at the point 22 of attachment, also commercially available. Other embodiments may also be employed to shield in RF the conductor 20 from adjacent circuit boards and their associated ground planes.

In FIGS. 2A-2B, the conductor 20 couples the telecoil 28 to the point 22 of the main ground plane 18 directly. Alternatively, and similar to that described with reference to FIG. 1A-1B, a second ground plane may be disposed in the second housing section 14 and couple to a telecoil 28, speaker 26, or both. In the embodiment of FIG. 2A-2B, the speaker 26 is disposed within the first housing section 12 and coupling to a user's hearing aid occurs between the mobile station telecoil 28 and a compatible telecoil in the hearing aid. An internal antenna 32 is shown near the speaker 26, but may be disposed at any of numerous convenient locations that minimizes coupling to the user.

Additionally, the embodiment of FIG. 2A-2B includes a full QWERTY keyboard that is split so that a first keypad section 16a is within the first housing section 12 (FIG. 2A) and a second keypad section 16b is within a second housing section 14 (FIG. 2C). FIG. 2C shows the second housing section but not in cutaway as it is shown in FIG. 2A. The portion of the QWERTY keyboard 16b within the second housing section 14 represents additional metallic components in the vicinity of the telecoil 28, but is an acceptable tradeoff of HAC improvement and space limitations. In FIG. 2C, the telecoil 28 is illustrated as being positioned off a central (vertical as illustrated) axis of the second housing section 14 for reasons detailed with respect to FIG. 7B. It is noted that the speaker 26 may be disposed in place of or alongside the illustrated telecoil 28 of FIG. 2C.

FIG. 3A is a planview block diagram of a slide-type mobile station 50. To better distinguish the housing sections 12, 14 in FIGS. 3A-3B, the second housing section 14 is outlined in double-lines. The second housing section 14 has extending arms 14b similar to those of FIG. 2B, except that those of FIGS. 3A-3B are slideably coupled to the first housing section 12 rather than hingedly coupled. Within the first housing section 12 are a microphone 27, a display 17, and a keypad 16. Within the second housing section is a speaker 26. FIG. 3A illustrates the housing sections 12, 14 extended relative to one another, and the arrows indicate how the slide-type mobile phone 50 would close.

FIG. 3B is an exploded block diagram of relevant components of the slide-type mobile phone of FIG. 3A, with the second housing section 14 hyper-extended relative to the first 12 to better illustrate one embodiment of the conductor 20. An internal antenna 32 is coupled to the first ground plane 18 to be resonant with it at operating frequencies. That antenna 32 may be disposed at the top of the first housing section 12 as illustrated, or elsewhere within or attached to the first housing section 12. A display circuit board 17b may preferably have its own ground plane (not separately shown) that is coupled to the first ground plane 18, or may be grounded directly to the first ground plane 18 itself.

The illustrated embodiment to couple the speaker 26 (or telecoil or second ground plane) of the second housing section 14 to the desired point 22 of the first ground plane 18 is by a sliding connector by which a fixed bump 20a protruding from one of the arms 14b contacts an extended strip 20b mounted to an exterior of the first housing. A first wire 20c couples the strip 20b to the desired point 22 on the first ground plane 18, and a second wire 20d couples the bump 20a to the speaker 26. Preferably, the strip 20b and the first 20c and second 20d wires are shielded by a ferrite carpet or the like as previously described. Embodiments for the conductor include imposing a flexible length of wire between the first housing section 12 and the arm 14b of the second housing section that is extended when the slideable housing sections 12, 14 are in one relative position and folded back on itself when they are in the opposite (e.g., extended) relative position.

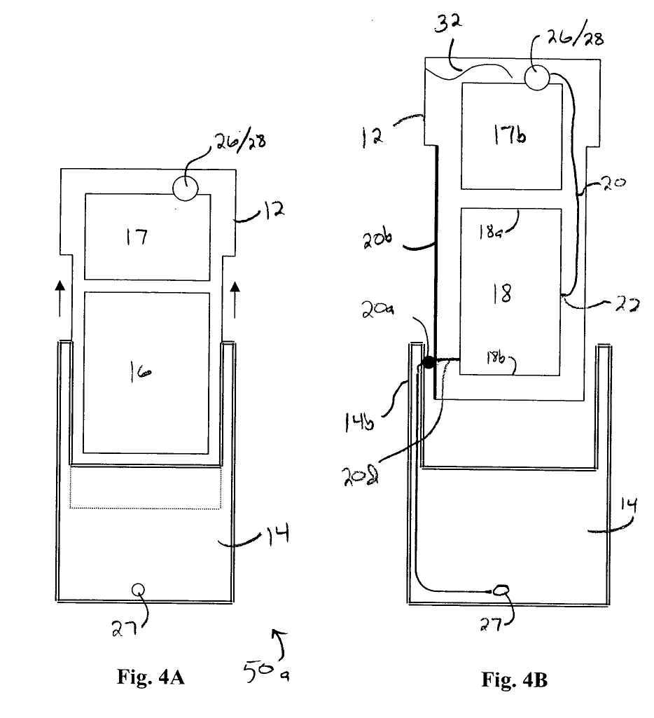

FIGS. 4A-4B are similar to FIGS. 3A-3B, but for a more traditional embodiment 50a of a slide-type phone, where the larger first housing section 12 houses the main circuit board and ground plane 18 and also the speaker 26 and/or telecoil 28. Like reference numbers indicate like components unless otherwise described. The display 17 and display circuit board 17b are as illustrated, adjacent to the main ground plane 18. The antenna 32 is disposed near the speaker/telecoil 26/28, though it may be disposed anywhere to minimize RF coupling with a user's hand or head. The microphone 27 is disposed in the second housing section 14, and couples to the main circuit board as illustrated by a strip 20d which need not be RF isolated or coupled to a particular position along the ground plane 18.

In this embodiment, the speaker/telecoil 26/28 are not so far spaced from the ground plane 18 as in the embodiment of FIGS. 3A-3B, but undesirable coupling is diminished by connecting the speaker/telecoil 26/28 through the conductor 20 to a point 22 preferably midway between opposed edges 18a, 18b of the ground plane 18. RF shielding (not shown), as detailed above with an RF blanket, chips, beads, or the like, isolates the conductor 20 from the circuit board, ground plane 18, and other relevant electronic components that may lie adjacent to the conductor 20.

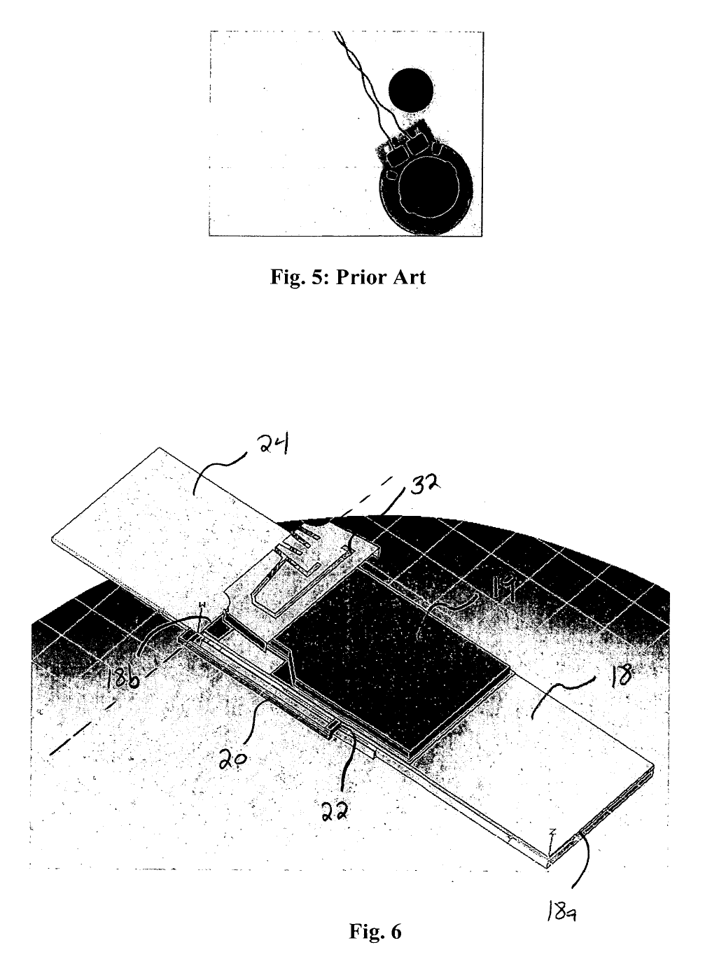

It is noted that the presence of the ferrite carpet causes a drop in antenna efficiency. However, the inventors have determined that the decibel loss due to sacrificed antenna efficiency is more than compensated by the RF field decrease caused by the ferrite carpet. As a comparison, FIG. 5 shows a micrograph of a prior art mobile phone speaker with unshielded wires, whereas FIG. 2A shows a telecoil 28 with similar wires shielded with a ferrite blanket 34.

FIG. 6 illustrates the relevant components of the embodiment of FIG. 2 in perspective view with more representative relative sizes and dispositions of the various components. The first 18 and second 24 ground planes are coupled mechanically through a hinge axis (not shown) through which the conductor 20 passes, and are physically separated along the dashed line which divides the first and second housing sections 12, 14. The conductor 20 couples to the first ground plane 18 at a point 22 approximately midway between opposed edges 18a, 18b, preferably between edges disposed furthest from one another as compared to any other opposed pairs of edges (in the typical case where the first ground plane 18 is rectangular). The antenna 32 is shown as disposed near the hinge axis rather than opposite thereto as in FIG. 2B, and a shield 19 overlies the main ground plane 18 to isolate it from other components, such as a graphical display interface. Such a shield 19 is commonly present in mobile stations, though not particularly shown in FIG. 2B, 3B or 4B.

FIGS. 7A-7B illustrate intensity of electric field strength overlain over the components of FIG. 5. Intensity of electric field is shown overlying the ground planes 18, 24 where darker colors indicate areas of progressively higher E-field intensity. FIG. 7A represents the first 18 and second 24 ground planes connected via a shortest-distance path, at their nearest corners 42, as representative of how they may be coupled in the prior art. No ferrite shielding is provided in the apparatus of FIG. 7A, and a region of highest E-field 44a spans the leftmost terminal edge 24a of the second ground plane 24, measuring 61 dB (V/m). FIG. 7B represents the identical apparatus as in FIG. 7A, but with ferrite carpet shielding between the conductor 20 and the various ground planes 18, 24, 17b, and also with the conductor 20 extended to couple to the first ground plane 18 at the point 22 approximately midway between the opposed edges 18a, 18b of that ground plane 18. A region 44b of highest E-field along the leftmost terminal edge 24a of the second ground plane 24 is limited to a relatively small area near the corner, and measures 51.1 dB (V/m), a measured drop of about 10 dB. Because the region 44b of maximum E-field in the improved model of FIG. 7B is isolated to only a small segment along the edge 24a of the second ground plane 24, as opposed to spanning that same edge 24a in the model of FIG. 7A, a telecoil 28 or speaker 26 may be disposed elsewhere along that edge 24 where the E-field is less than the illustrated maximum. Traditionally, the speaker is disposed symmetric about a central axis of the housing sections 12 or 14. HAC improvement may be obtained in mounting the speaker asymmetrically or off that bisecting axis. An ideal position as determined by the radiation patter of FIG. 7B is shown as a telecoil and/or speaker 26/28 in FIG. 7B, though it is understood that the position for a telecoil or speaker is not limited to being disposed directly over the second ground plane 24.

There are enumerated categories of HAC phones, designated M1 through M4 (and MX, a special category), by which telephones are divided according to E and H field emissions for hearing-aid compatibility. Using some or all of the above improvements (wire shielding, reducing metallic volume in second housing section, coupling to first ground plane at a position of low E field) can reduce the E and H fields emitted from mobile telephones, moving that phone into a more compatible category and enabling the manufacturer to meet the FCC requirements for numbers of models and percentages of phones that are HAC. Testing of E and H field emissions (RF emissions) is particularly outlined in ANSI standard 63.19, which is generally accepted for classifying phones into the proper HAC category. Similar categories exist for T-coil signal compatibility, using categories T1-T4 as well as TX, and that same ANSI standard describes T-coil compatibility testing. HAC phones are generally considered those within the M3, M4, T3, or T4 categories, depending upon whether they rely on t-coil coupling or not.

Given the above, it is particularly noted that a manufacturer of mobile phones may readily make HAC compatible phones (or equivalently increase the HAC category of an exiting model, such as from no HAC category to M3 or from M3 to M4) by adapting the design for an existing model so that a ferrite shield is added to wiring that goes between the first and second housing sections 12, 14, and/or by moving the point at which the conductor couples to the first ground plane substantially nearer toward the geometric center of the first ground plane, as described in detail above. Whether the move in contact point is substantial or not depends on the intended result: reduction of electric/magnetic fields in the vicinity of the telecoil or speaker to which the user's hearing aid will be closest. Whether the fields at a telecoil or speaker are the relevant fields may be readily determined by the manufacturer's operating manual and related materials.

The above is not to say that a manufacturer physically adapts already-manufactured mobile phones, but rather makes the above change(s) to an existing phone design and manufactures a new HAC mobile phone from the adapted design. This would be a particularly efficient way for mobile phone manufacturers to meet the HAC and time requirements of the FCC ruling, detailed in the Background section, that eliminated the exception in the HAC Act for mobile phones. Such modifications may be readily and economically implemented without substantial re-design of a mobile phone, and a simple comparison between two phones would indicate if one or both of the above improvements were made to an exiting model to raise the HAC category of the improved (HAC compatible) model as compared to the original. Reducing the volume of metallic materials in the second housing section 14 would represent a more substantial re-design.

Although described in the context of particular embodiments, it will be apparent to those skilled in the art that a number of modifications and various changes to these teachings may occur. Thus, while the invention has been particularly shown and described with respect to several embodiments thereof, it will be understood by those skilled in the art that certain modifications or changes may be made therein without departing from the scope and spirit of the invention as set forth above, or from the scope of the ensuing claims.

What is claimed is:

1. An electronic device comprising:
a ground plane defining two opposed edges;
an electrical component spaced from the ground plane; and
an electrical conductor that couples the electrical component to a point on the ground plane that is substantially spaced from each of said opposed edges,
wherein the electrical component does not overlie the point with respect to the ground plane.

2. The electronic device of claim 1, where the opposed edges define a length L between them, and the point is located at least L/3 from each opposed edge.

3. The electronic device of claim 2, where the point is located approximately L/2 from each opposed edge.

4. The electronic device of claim 1, further comprising RF shielding between at least a portion of said electrical conductor and the ground plane.

5. The electronic device of claim 4, where said RF shielding comprises a ferrite material disposed over the electrical conductor.

6. The electronic device of claim 4, wherein the RF shielding comprises ferrite chips.

7. The electronic device of claim 1, where the electrical component comprises a speaker.

8. The electronic device of claim 1, where the electrical component comprises a telecoil.

9. The electronic device of claim 1 comprising first and second housing sections moveable relative to one another between open and closed positions, wherein the ground plane is disposed within the first housing section and the electrical component is disposed within the second housing section.

10. The electronic device of claim 9, where the first and second housing are hingedly coupled.

11. The electronic device of claim 9, where the first and second housing are slideably coupled.

12. The electronic device of claim 9, wherein the first housing section further comprises an active antenna that is resonantly coupled to the ground plane, said antenna disposed such that when the first and second housing sections are in the open position, the antenna lies between the ground plane and the electrical component.

13. The electronic device of claim 9, where the said ground plane is a first ground plane, and where the electrical component comprises a second ground plane.

14. The electronic device of claim 13, where the second ground plane defines two opposed edges and the electrical conductor couples the second ground plane at a terminal point along one of the opposed edges of the second ground plane.

15. The electronic device of claim 9, where the first housing section further comprises a visual display and the second housing section defines a plurality of edges that at least partially frame the display when the housing sections are in the closed position.

16. The electronic device of claim 1, where the device comprises a hearing aid compatible mobile station.

17. A mobile station comprising:
an antenna and a ground plane resonant therewith;
an electrical component spaced from the ground plane; and
a conductor for electrically coupling the electrical component to a connection point on the ground plane that exhibits an electric field that is no greater than about one third of a maximum electric field about said ground plane at least when said mobile station operates in a receiving mode,
wherein the electrical component does not overlie the connection point with respect to the ground plane.

18. The mobile station of claim 17, where the connection point exhibits an electric field that is substantially a minimum at least when said mobile station operates in a receiving mode.

19. The mobile station of claim 17 comprising first and second housing sections that are movable relative to one another between an open and a closed position, wherein the antenna and ground plane are disposed within the first housing section and the electrical component is disposed within the second housing section.

20. The mobile station of claim 19, where the said ground plane comprises a first ground plane and the electrical component comprises a second ground plane, and where the second ground plane is not resonant with the antenna when the mobile station operates in a receiving mode.

21. The mobile station of claim 17 further comprising means disposed between the conductor and the ground plane for shielding RF signals.

22. The mobile station of claim 20 wherein the means for shielding comprises a ferrite material.

23. A method for providing a hearing aid compatible wireless electronic device, comprising:
providing a housing of a wireless electronic device;
disposing an antenna and a ground plane coupled to and resonant with said antenna within the housing;
disposing an electrical component within said housing and spaced from said ground plane; and
coupling said electrical component by a conductor to a point of said ground plane with an electrical conductor, said first point disposed substantially spaced from each of two opposed edges of said ground plane, and said electrical component not overlying the point with respect to the ground plane.

24. The method of claim 23, further comprising:
disposing RF shielding between the conductor and the ground plane.

25. The method of claim 24, wherein the RF shielding comprises a ferrite material.

26. The method of claim 23 where the point is disposed substantially equidistant between the opposed edges of the ground plane.

27. The method of claim 23 wherein the wireless electronic devices comprises a mobile station.

28. The method of claim 23 wherein the housing comprises first and second housing sections that are extendable relative to one another, the antenna and ground plane is disposed within the first housing section, and the electronic component is disposed within the second housing section.

29. A wireless electronic device comprising:
an antenna;
grounding means coupled to said antenna and resonant therewith when said antenna is active, said grounding means defining two opposed edges;
an electrical component spaced from an edge of said grounding means at least when said antenna is active in a transmitting mode; and
coupling means for electrically coupling said electrical component to a point of said grounding means that is substantially spaced from each of said two opposed edges,
wherein the electrical component is disposed so as to not overlie the point with respect to the ground plane.

30. The wireless electronic device of claim 29, where the grounding means comprises a first ground plane, and the electrical component is a second ground plane that is not resonant with the antenna when said antenna is active.

31. The wireless electronic device of claim 29 wherein the point is substantially equidistant between the two opposed edges.

32. The wireless electronic device of claim 31, wherein the device comprises first and second housing sections moveable relative to one another, wherein the antenna and grounding means are disposed within the first housing section and the electrical component is one of a speaker and a telecoil disposed within the second housing section, the device further comprising ferrite shielding means disposed to electrically shield the coupling means from the grounding means.
